(19) United States
(12) Patent Application Publication
(10) Pub. No.: US 2003/0098973 A1
(43) Pub. Date: May 29, 2003

(54) Distance measuring apparatus

(76) Inventors: Dierk Schmidt, Leinfelden-Echterdingen (DE); Juergen Luginsland, Leinfelden-Echterdingen (DE); Joerg Stierle, Waldenbuch (DE); Peter Wolf, Leinfelden-Echterdingen (DE); Gunter Flinspach, Leonberg (DE)

Correspondence Address: Striker Striker & Stenby, 103 East Neck Road, Huntington, NY, 11743, US

(21) Appl. No.: 09/979,960

(22) PCT Filed: Mar. 9, 2001
(86) PCT No.: PCT/DE01/00880

(30) Foreign Application Priority Data
Mar. 31, 2000 (DE) 100 16 309.2

(51) Int. Cl. G01J 1/00

(52) U.S. Cl. 356/213

(57) ABSTRACT

The invention is based on a distance measuring apparatus comprising at least one transmitter unit (14, 16) located in a housing (10, 12) for emitting a photometric signal, in particular a laser beam, and at least one receiver unit (20, 22) for receiving a portion of a measuring signal reflected on a remote object, and comprising at least one central processor.

It is proposed that at least one sensor is located in the housing (10, 12), via which at least one angle of radiation (24) of the photometric signal can be measured relative to at least one reference value.

### PRIOR ART

The invention is based on a distance measuring apparatus according to the preamble of claim 1.

A distance measuring apparatus forming the general class is made known in DE 198 09 683 A1 that can be guided freely by hand to measure distances without a stand. An additional housing for holding the distance measuring apparatus is proposed in DE 198 09 683 A1, into which the distance measuring apparatus with its housing can be inserted and connected to a stand. A stand-based operation of the distance measuring apparatus can be made possible in simple fashion by means of the additional housing.

If a distance between two points cannot be measured directly, for example, because a possible reflecting point is covered by an object, it is known to carry out an indirect length measurement using the distance measuring apparatus forming the general class. For this, a first replacement distance between a measuring point and a starting point of the required distance is measured in a first step, wherein the first replacement distance must extend at a right angle to the required distance. In a second step, a second replacement distance between the measuring point and an end point of the required distance is measured. In a third step, the required distance is calculated with the two replacement distances and the assumed right angle between the first replacement distance and the required distance using a central processor in the distance measuring apparatus by applying the Pythagorean theorem.

### ADVANTAGES OF THE INVENTION

The invention is based on a distance measuring apparatus comprising at least one transmitter unit located in a housing for emitting a photometric signal, in particular a laser beam, and at least one receiver unit for receiving a portion of a measuring signal reflected on a remote object and comprising at least one central processor. Instead of a laser, other light sources appearing reasonable to one skilled in the art can also be used, such a special diodes, etc.

It is proposed that at least one sensor is located in the housing, via which at least one angle of radiation of the photometric signal can be measured relative to at least one reference value. Due to the sensor, an assumption of a right angle between one replacement distance and the desired distance, and errors resulting therefrom, can be avoided in an indirect measurement of a distance by means of two replacement distances. By measuring the angle, a distance in any triangle can be determined indirectly.

A particularly compact distance measuring apparatus can further be achieved with which a distance can advantageously be determined indirectly with and without a stand. Using one or more measured angles of rotations and distances, various arithmetic operations appearing reasonable to one skilled in the art can be carried out in the central processor. Certain angles and/or slopes of walls, floors, ceilings, etc., distances, surfaces and/or various volumes can be determined, for example, by means of multiplication, subtraction, integration, application of the cosine emission law, etc.

If the transmitter unit, at least, can be swivelled relative to the housing around at least one, preferably around two axes, desired angles of radiation can be measured simply and exactly without a stand. A starting measuring point can be easily adhered to because the angle of radiation can be changed without having to move the housing of the distance measuring device. So as to achieve the least possible interferences of light beams from the environment, the receiver unit—together with the transmitter unit—is advantageously supported in a fashion that allows it be swivelled.

A desired angle of rotation can be measured between two or more measured distances, or it can be measured relative to a direction specified firmly from the outside, wherein individual measurements, an expenditure resulting therefrom, and sources of error can be avoided. The direction can be measured from the outside by means of the force of gravity, that is, an angle of inclination can be measured via a sensor and a force of gravity acting on it, and/or the direction can be specified by geomagnetism, which can be measured via a sensor, in particular a compass, and for which an angle of radiation can be determined. Numerous sensors appearing reasonable to one skilled in the art can be used to take the force of gravity and/or the geomagnetism into account.

Instead of measuring an angle of rotation of the transmitter unit in the housing, an angle of rotation of the housing can also advantageously be measured via at least one sensor. The transmitter unit and the receiver unit can be firmly secured in the housing of the distance measuring apparatus, and a particularly simple and cost-effective design can be achieved.

In a further embodiment of the invention, it is proposed that the housing can be swivelled around at least one axis via a stand receptacle and it can be connected to a stand, and an angle of rotation of the housing relative to the stand can be measured via at least one sensor. Using a stand, a simple handling can be achieved and, in particular, handling errors or measuring errors can be prevented, and, in fact, particularly because an exact starting position can be easily adhered to for carrying out multiple measurements.

The stand receptacle and/or a support region of the stand can be designed in a fashion that allows it to be swivelled by means of various joints appearing reasonable to one skilled in the art, preferably around at least two axes altogether, for example, via a ball-and-socket joint, a universal joint, etc. If the stand receptacle is supported in the housing in a fashion that allows it to be swivelled around at least one axis, an angle of rotation can be measured with a particularly simple design via a sensor, e.g., an incremental sensor.

It is further proposed that, after selection of a certain program, the central processor expects at least a second measured value in addition to a first measured value, and, in fact, an angle of rotation and a second distance in particular. Comfort can be increased, handling errors can be prevented, and a measuring time for determining an indirect distance can be shortened. If a second distance was measured, the indirect distance can automatically be calculated and displayed. So as to make certain measuring functions possible, it can be reasonable, however, to design the automatic function, that is, the waiting for a second measured value and/or the automatic output of the indirect distance, to be deactivatable, so that an angle or a slope of a first plane can be measured relative to a second plane, etc., for example.

If the position of a swivelling axis of the housing and/or the transmitter unit is taken into consideration by the central processor, measuring errors can be prevented. In a direct distance measurement, if the central processor assumes that a front facing the operator is the starting point, then the starting point—after a selection of a certain program for the indirect measurement of a distance—is advantageously, automatically placed in a point of intersection of a line formed by the light signal and one or more swivelling axes. Furthermore, the starting point can be changed automatically by the placement of the housing on a stand.

In a further embodiment of invention it is proposed that, after a selection of a certain program, the central processor automatically adds at least two measured distances. Comfort can be increased and, in particular, a “repositioning measurement” can be carried out simply and quickly, which makes it possible to perform a distance measurement over large distances that exceed a measuring range of the distance measuring apparatus. A specified angle of rotation between the measured distances is thereby 180°. Other angles of rotation between the distances to be added are also feasible on principle, however.

So as to prevent measuring errors or operator errors, an angle of rotation between the distances can advantageously be controlled via at least one control device. The control device can comprise mechanical detent positions that can be designed to be rigid or adjustable by an operator. The control device can further comprise a display device via which a set angle of rotation can be output.

If an angle of radiation can be set via a control unit and an electrically actuated setting unit, comfort can be increased. Furthermore, a particularly exact setting, in particular an angular setting, can be achieved by means of the electrically actuated setting unit. The setting unit can have an electric motor or an electromagnet, for example, which is connected via a control gear to a transmitter unit that can be swivelled, or to a stand receptacle. The setting unit can be partially or fully integrated in the housing of the distance measuring apparatus or in the stand.

### DRAWING

Further advantages arise from the following drawing description. Exemplary embodiments of the invention are presented in the drawing. The drawing, the description, and the claims contain numerous features in combination. One skilled in the art will appropriately consider them individually as well and combine them into reasonable further combinations.

FIG. 1 shows a laser distance measuring apparatus diagonally from above when installed on a stand,

FIG. 2 shows the laser distance measuring apparatus in FIG. 1 diagonally from below,

FIG. 3 shows the laser distance measuring apparatus in FIG. 1 directly from below

FIG. 4 shows the laser distance measuring apparatus in FIG. 1 in a measuring procedure for the indirect measurement of a distance,

FIG. 5 shows a schematic representation of a repositioning measurement,

FIG. 6 shows an enlarged and schematically represented sectional drawing through a stand receptacle,

FIG. 7 shows a view in the direction VII in FIG. 6,

FIG. 8 shows a variant according to FIG. 1 with a transmitting and receiver unit that can be swivelled, and

FIG. 9 shows a schematic representation of a setting unit for swivelling a transmitting and receiver unit in FIG. 8.

### DESCRIPTION OF THE EXEMPLARY EMBODIMENTS

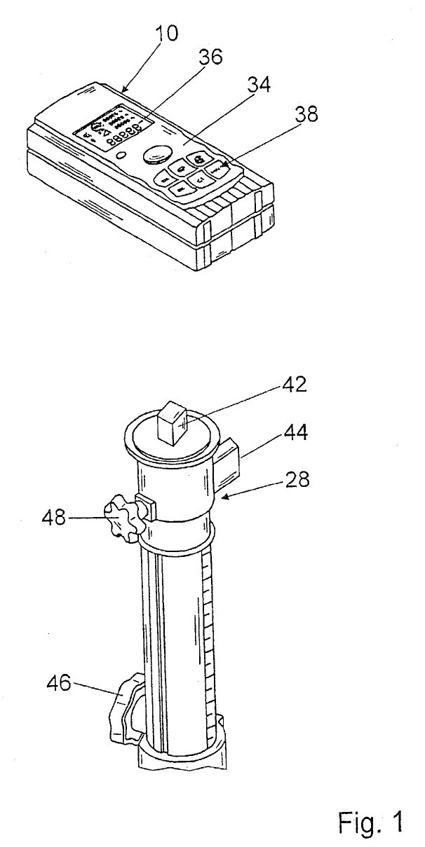

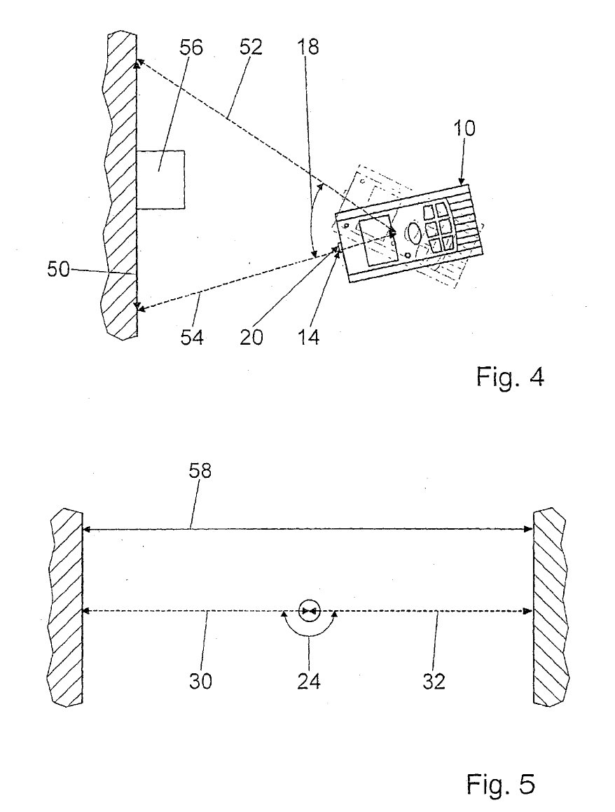

FIG. 1 shows a laser distance measuring apparatus comprising a transmitter unit 14 located in the housing 10 for emitting a laser measuring signal (FIGS. 3 and 4). The transmitter unit 14 has a laser diode—not shown in greater detail—and a collimation lens, with the aid of which the measuring signal can be directed, bundled, through an outlet channel.

Furthermore, the laser distance measuring apparatus comprises a receiver unit 20 having a lens—not shown in greater detail—that captures portions of measuring signals reflected on an object and directs them to an optoelectric receiver. The receiver—which is preferably designed as an avalanche photodiode—receives the measuring signal portions and feeds them, in electronic form, to a central processor or evaluation unit, which are not shown in greater detail, either.

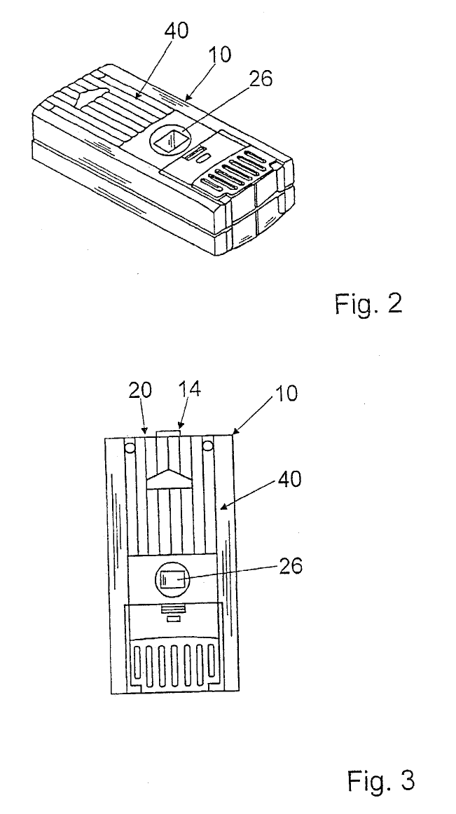

A display device 36 and multiple operator buttons 38 are located on a top side 34 of the laser distance measuring apparatus (FIG. 1). A stand receptacle 26 is located in the housing 10 on a back side 40 of the laser distance measuring apparatus (FIGS. 2 and 3), which comprises a recess having a rectangular cross-section, via which the stand receptacle 26 can be connected to two bolts 42, 44—designed in accordance with the recess—of a stand 28 in a fashion that secures them against rotation (FIG. 1).

The stand receptacle 26 is supported in the housing 10 of the laser distance measuring apparatus in a fashion that allows it to be rotated around one axis. The housing 10 of the laser distance measuring apparatus can be connected to the stand 28 via the stand receptacle 26 in a fashion that allows it to swivel around the axis, and, in fact, the laser distance measuring device can be swivelled 360° on the bolt 42 in a horizontal plane, and 360° on the bolt 44 in a vertical plane. The height of the bolts 42, 44 can be adjusted via a first screw 46 and, with a second screw 48, the bolts 42, 44 and, in particular, the bolt 44, can be swivelled in a horizontal plane and then fixed in place.

According to the invention, an incremental angle sensor—not shown in greater detail—is located in the housing 10, and, in fact, in the region of a support point of the stand receptacle 26, via which an angle of rotation 18 of the housing 10 relative to the stand 28 between a first measured replacement distance 52 and a second measured replacement distance 54 can be measured (FIG. 4). A distance 50—which cannot be measured directly due to an object 56—can be calculated in any triangle via the central processor by measuring the two replacement distances 52, 54 and the angle of rotation 24 between the replacement distances 52, 54, by using the cosine emission law, in fact. Measuring errors caused by assumed circumstances that are not exactly present, and by changing a starting position, can be reliably avoided.

Once a program for the indirect measurement of a distance has been selected, the central processor expects an angle of rotation 24 and a second replacement distance 54 in addition to a first replacement distance 52. Furthermore, when the program is selected, a starting point—from which the replacement distances 52, 54 are measured—of a face of the housing 10 opposite to the transmitter unit 14 is placed in the middle of the stand receptacle 26. The starting point lies in a point of intersection of the swivelling axis and a line formed by the laser measuring signal.

In a further program that can be selected by an operator, two consecutively measured distances 30, 32 are automatically added by the central processor (FIG. 5). The program can be used particularly advantageously for a repositioning measurement, in which a total distance 58 that exceeds a measuring range of the laser distance measuring apparatus can be determined by measuring two distances 30, 32 and by subsequent addition, wherein the laser distance measuring apparatus is swivelled at a swivelling angle 24 of 180° between the first and the second measurement (FIG. 5).

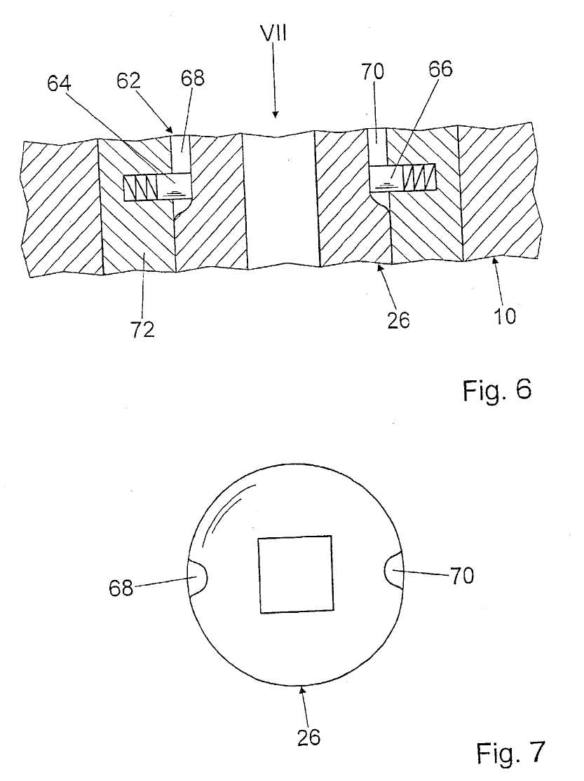

The angle of rotation 18 and, in particular, the angle of rotation 24 of 180° of the housing 10 can be controlled via a control device 62 that, on the one hand, constantly outputs the angle of rotation 18, 24 of the housing 10 between a first and a second measurement via the display device 36 in an appropriate program, and comprises two spring-loaded detent elements 64, 66 supported in a detent ring 74 and arranged in such a fashion that they are offset by 180° over the extent of the stand receptacle 26 (FIGS. 6 and 7). The detent elements 64, 66 lock in place in certain rotary settings in recesses 68, 70 of the stand receptacle 26.

So that a first measurement can be carried out in a desired direction when performing a repositioning measurement, the housing 10 is advantageously locked in place via the detent elements 64, 66. The screw 48 of the stand is then loosened, so that the housing 10—together with the bolt 42—can be pointed in the desired direction. Once the desired direction for the first measurement is achieved, the bolt 42 is fixed in the direction of rotation via the screw 48. After a first measurement, the housing 10 can be swivelled 180° via the stand receptacle 26. The detent elements 64, 66 are thereby first displaced radially toward the outside and then lock back in place in the recesses 68, 70 after an angle of rotation 24 of 180°.

If, due to an operator error or an unexact alignment of the apparatus, for example, the angle of rotation 24 of 180° between the two distances 30, 32 is not adhered to exactly in a repositioning calculation, an integral arithmetic routine in the central processor of the distance measuring apparatus makes it possible for the angular deviation to be detected, and a measured value of the total distance 58 is displayed for an angle of exactly 180° between the distances 30, 32.

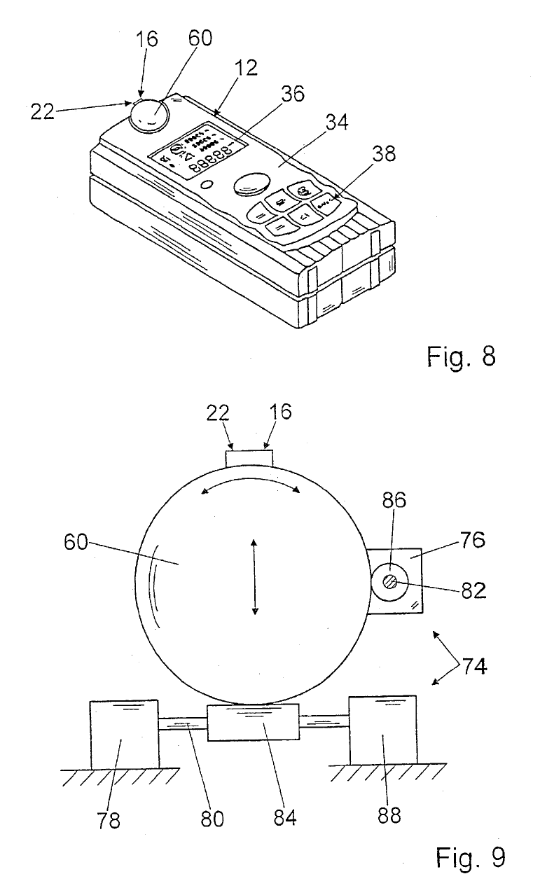

An alternative laser distance measuring apparatus comprising housing 12 and a transmitting and receiver unit 16, 22 that can be swivelled relative to the housing 12 is shown in FIG. 8. Essentially, the same reference numerals are used to label components that remain the same. Furthermore, the description of the exemplary embodiment in FIGS. 1 through 7 can be referred to with regard for features and functions that remain the same.

The transmitter and receiver units 16, 22 are supported in a spherical head 60 that, after selection of a certain program via the available operator buttons 38, a control unit—not shown in greater detail—and a setting unit 74 can be swivelled (FIGS. 8 and 9). The setting unit 74 comprises two electric motors 76, 78, via which two shafts 80, 82 standing perpendicular to each other can be driven. The shafts 80, 82 are connected to the spherical head 60 via rollers 84, 86 and are supported in bearing components 88. Angle sensors—not shown in greater detail—are located in the bearing components 88, via which the angle of rotation of the spherical head 60 can be measured indirectly via the shafts 80, 82. An angle of rotation measured between two distances is output via the display device 36 and can thereby be monitored.

If a program for a repositioning measurement is selected, the spherical head 60 is automatically swivelled 180° via the control unit and the setting unit 74 after a first measurement.

Numerous other setting units are feasible in addition to the setting unit 74 described in the exemplary embodiment in FIG. 9. So that the laser measuring signals and portions of measuring signals received by the receiver unit can be flexibly emitted in a selected direction or flexibly received from a selected direction, the signals are reflected accordingly via a device not shown in greater detail. The device comprises flexible cable that conducts the signals, but it can also comprise mirrors and/or lenses that can be swivelled and that deflect the signals.

Reference Numerals

| | | | |
|---|---|---|---|
| 10 | Housing | 56 | Object |
| 12 | Housing | 58 | Total distance |
| 14 | Transmitter unit | 60 | Spherical head |
| 16 | Transmitter unit | 62 | Control device |
| 18 | Angle of radiation | 64 | Detent element |
| 20 | Receiver unit | 66 | Detent element |
| 22 | Receiver unit | 68 | Recess |
| 24 | Angle of radiation | 70 | Recess |
| 26 | Stand receptacle | 72 | Detent ring |
| 28 | Stand | 74 | Setting unit |
| 30 | Distance | 76 | Electric motors |
| 32 | Distance | 78 | Electric motors |
| 34 | Top side | 80 | Shaft |
| 36 | Display device | 82 | Shaft |
| 38 | Operator buttons | 84 | Roller |
| 40 | Back side | 86 | Roller |
| 42 | Bolt | 88 | Bearing component |
| 44 | Bolt | | |
| 46 | Screw | | |
| 48 | Screw | | |
| 50 | Line segment | | |
| 52 | Replacement distance | | |
| 54 | Replacement distance | | |

1. Distance measuring apparatus comprising at least one transmitter unit (14, 16) located in a housing (10, 12) for emitting a photometric signal, in particular a laser beam, and at least one receiver unit (20, 22) for receiving a portion of a measuring signal reflected on a remote object, and comprising at least one central processor, characterized in that at least one sensor is located in the housing (10, 12), via which at least one angle of radiation (24) of the photometric signal can be measured relative to at least one reference value.

2. Distance measuring apparatus according to claim 1, characterized in that the transmitter unit (16), at the least, can be swivelled around at least one axis relative to the housing (12).

3. Distance measuring apparatus according to claim 1 or 2, characterized in that an angle of radiation can be measured via at least one sensor relative to a direction firmly specified from the outside.

4. Distance measuring apparatus according to claim 3, characterized in that an angle of inclination can be measured via at least one sensor by means of a gravitational force acting on it.

5. Distance measuring apparatus according to claim 3 or 4, characterized in that at least one direction specified by the geomagnetic field can be detected via at least one sensor, and an angle of rotation relative to the direction can be measured.

6. Distance measuring apparatus according to one of the preceding claims, characterized in that an angle of rotation (18, 24) of the housing (10) can be measured via at least one sensor.

7. Distance measuring apparatus according to claim 6, characterized in that the housing (10) can be swivelled around at least one axis via a stand receptacle (26) and can be connected to a stand (28), and an angle of rotation (18, 24) of the housing (10) relative to the stand (28) can be measured via at least one sensor.

8. Distance measuring apparatus according to claim 7, characterized in that the stand receptacle (26) is supported in the housing (10) in a fashion that allows it to be rotated around at least one axis.

9. Distance measuring apparatus according to one of the preceding claims, characterized in that, after a certain program is selected, the central processor expects at least a second measured value in addition to a first measured value.

10. Distance measuring apparatus according to one of the preceding claims, characterized in that the central processor takes the position of a swivelling axis of the housing (10) and/or the transmitter unit (16) into account.

11. Distance measuring apparatus according to one of the preceding claims, characterized in that, after a certain program is selected, the central processor automatically adds at least two measured distances (30, 32).

12. Distance measuring apparatus according to claim 11, characterized in that a specified angle of rotation (24) between the distances (30, 32) is 180°.

13. Distance measuring apparatus according to claim 11 or 12, characterized in that an angle of rotation (24) between the distances (30, 32) can be controlled via at least one control device (62).

14. Distance measuring apparatus according to claim 13, characterized in that, if the angle of rotation of 180° between the distances (30, 32) is not adhered to exactly, the central processor mathematically corrects the angular error, and the measured value of the total distance (58) for an angle of exactly 180° between the distances (30, 32) is displayed.

15. Distance measuring apparatus according to one of the preceding claims, characterized in that an angle of radiation can be adjusted via a control unit and an electrically actuated setting unit (74).
